(19) United States
(12) Patent Application Publication
(10) Pub. No.: US 2009/0109137 A1
(43) Pub. Date: Apr. 30, 2009

(54) PLASMA DISPLAY PANEL

(76) Inventors: Hee-Joun You, Suwon-si (KR); Sung-Yong Lee, Suwon-si (KR); Yong-Woo Jung, Suwon-si (KR); Chong-Gi Hong, Suwon-si (KR)

Correspondence Address: CHRISTIE, PARKER & HALE, LLP, PO BOX 7068, PASADENA, CA, 91109-7068, US

(21) Appl. No.: 12/256,401

(22) Filed: Oct. 22, 2008

(30) Foreign Application Priority Data
Oct. 24, 2007 (KR) 10-2007-0107440

(51) Int. Cl. G09G 3/28

(52) U.S. Cl. 345/60

(57) ABSTRACT

A plasma display panel including a first and second substrates. A plurality of discharge electrodes and a barrier rib structure are between the substrates. A plurality of discharge cells are defined between the substrates and at least one spacer is between the substrates to maintain a substantially constant distance between the substrates. At least one groove is in at least one of the substrates with the spacer in the groove. A frit is between the substrates to seal the substrates. Phosphor layers are in the discharge cells, and a discharge gas is filled in the discharge cells.

### CROSS-REFERENCE TO RELATED PATENT APPLICATION

This application claims priority to and benefit of Korean Patent Application No. 10-2007-0107440, filed on Oct. 24, 2007 in the Korean Intellectual Property Office, the entire disclosure of which is incorporated herein by reference.

### BACKGROUND OF THE INVENTION

1. Field of the Invention

The present invention relates to a plasma display panel, and more particularly, to a plasma display panel having at least one of spacer.

2. Description of the Related Art

Plasma display panels have recently been considered as replacement for conventional cathode ray tube display devices. A plasma display panel includes two substrates each having a plurality of electrodes and a discharge gas sealed between the substrates. A discharge voltage is applied to the electrodes to generate UV rays to excite phosphors formed on one of the substrates to display a desired image.

Such a plasma display panel is fabricated by arranging discharge electrodes and a barrier rib structure between two substrates to form discharge cells. A frit with a predetermined thickness is applied onto the inner edges of the substrates to seal the space between the substrates, and then a discharge gas is injected between the substrates.

To fabricate a plasma display panel, it is important to maintain the gap between two substrates at a substantially constant level. If not so, noise and vibration are likely to occur in the plasma display panel. To this end, conventionally, a plurality of spacers are disposed between two substrates in order to maintain a suitable gap between the substrates.

### SUMMARY OF THE INVENTION

Embodiments of the present invention provide a plasma display panel in which substrates can be easily aligned with each other.

Embodiments of the present invention provide a plasma display panel with increased luminance and discharge efficiency.

According to an embodiment of the present invention, there is provided a plasma display panel including a first and second substrates facing each other. A plurality of discharge electrodes are disposed between the first and second substrates. A barrier rib structure is between the first and second substrates together with the first and second substrates defining a plurality of discharge cells. At least one spacer is between the first and second substrates for maintaining a substantially constant distance between the first and second substrates. At least one groove is in at least one of the substrates with the at least one spacer in the at least one groove. A frit is between the first and second substrates for sealing the first and second substrates together. A plurality of phosphor layers are in the plurality of discharge cells, and a discharge gas is filled in the plurality of discharge cells.

At least one dielectric layer may be between the first and second substrates and cover the plurality of discharge electrodes.

A protective layer may be on the at least one dielectric layer.

The plurality of discharge electrodes may be inside the barrier rib structure.

At least one of the plurality of discharge electrodes may surround at least parts of the discharge cells.

The barrier rib structure may have a substantially sheet shape.

The at least one spacer may include at least one of glass, metal, or ceramic.

The at least one spacer is made of material that has been ground into powder.

The at least one spacer includes a plurality of spacers, and the frit may be between the plurality of spacers.

The at least one spacer is proximate to the frit.

The at least one groove may include a plurality of grooves in both substrates, and the at least one spacer may include a plurality of spaces each is in a corresponding one of the plurality of grooves.

The at least one groove may be in one of the first and second substrates. One end of the at least one spacer may be in the at least one groove, and the other end of the at least one spacer may be fixed on the other one of the first and second substrate.

Accordingly, it is easy to align a first and second substrates with one another in a plasma display panel according to the embodiments of the present invention.

In another embodiment, a plasma display panel is provided. The plasma display panel includes a first substrate, a second substrate facing the first substrate, a barrier rib structure, and a plurality of discharge electrodes. The barrier rib structure is between the first substrate and the second substrate. The barrier rib structure has a plurality of openings each exposing a corresponding portion of the first substrate to a corresponding portion of the second substrate. The plurality of discharge electrodes in the barrier rib structure together with the first substrate and the second substrate define a plurality of discharge cells. At least one spacer is between the first substrate and the second substrate for maintaining a substantially constant distance between the first substrate and the second substrate. At least one groove located in at least one of the first substrate and the second substrate, wherein the at least one spacer is in the at least one groove. A frit is between the first substrate and the second substrate for sealing the first and second substrates together.

A surface of at least one of the plurality of openings may be substantially perpendicular to the first substrate and the second substrate.

At least one of the plurality of discharge electrodes may surround at least one of the plurality of openings.

At least one of the plurality of openings may have a substantially cylindrical shape.

### BRIEF DESCRIPTION OF THE DRAWINGS

The above and other features and aspects of the present invention will become more apparent by describing in detail exemplary embodiments thereof with reference to the attached drawings in which:

FIG. 1 is a partially exploded perspective cut-away view of a plasma display panel according to a first embodiment of the present invention;

FIG. 2 is a cross sectional view of the plasma display panel of FIG. 1 taken along the line II-II;

FIG. 3 is a partial cross sectional view of a modified example of the plasma display panel of FIG. 1;

FIG. 4 is a partially exploded perspective view of a plasma display panel according to a second embodiment of the present invention; and

FIG. 5 is a cross sectional view of the plasma display panel of FIG. 4 taken along the line V-V.

### DETAILED DESCRIPTION OF THE EMBODIMENTS

Hereinafter, exemplary embodiments of the present invention will be described in detail with reference to the accompanying drawings.

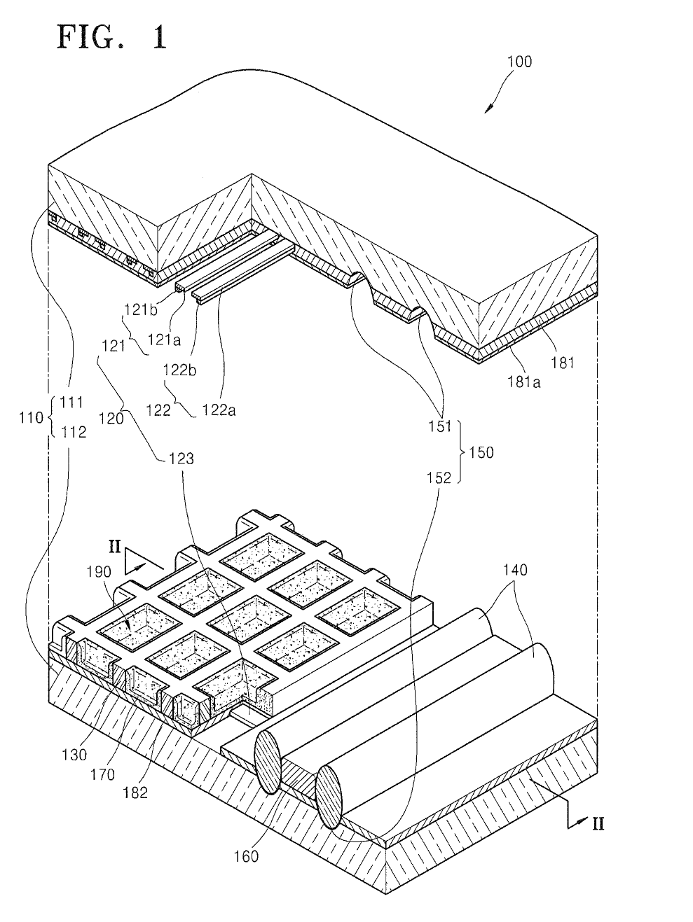

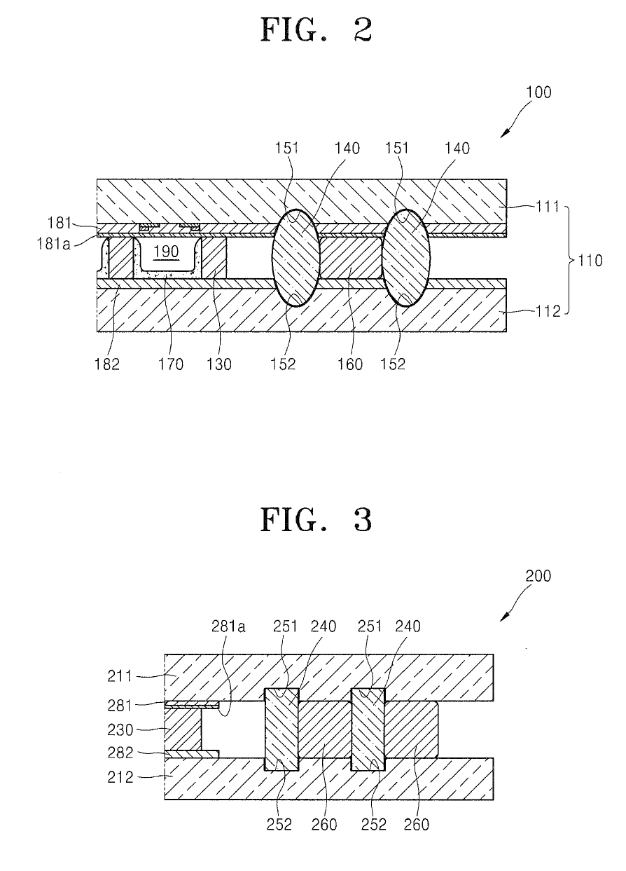

FIG. 1 is a partially exploded perspective cut-away view of a plasma display panel 100 according to a first embodiment of the present invention. FIG. 2 is a cross sectional view of the plasma display panel 100 of FIG. 1 taken along the line II-II.

As illustrated in FIGS. 1 and 2, the plasma display panel 100 includes a pair of substrates 110, discharge electrodes 120, a barrier rib structure 130, spacers 140, grooves 150, and phosphor layers 170.

The pair of substrates 110 include a first substrate 111 and a second substrate 112. The first and second substrates 111 and 112 are arranged to face each other while being spaced at a suitable distance (e.g., a predetermined distance) from each other. In particular, the first substrate 111 is formed of transparent material (e.g., transparent glass) so as to allow visible light to pass through the first substrate 111.

In the first embodiment, visible light generated by a discharge passes through the first substrate 111 since the first substrate 111 is transparent, but the present invention is not limited thereto. That is, the first and second substrates 111 and 112 may be respectively opaque and transparent, but alternatively both of them may be transparent. Also, the first and second substrates 111 and 112 may be formed of a semi-transparent material, or a color filter may be included on or inside them.

The discharge electrodes 120 are disposed between the first and second substrates 111 and 112. The discharge electrodes 120 includes common electrodes 121, scan electrodes 122, and address electrodes 123.

Specifically, the common electrodes 121 and the scan electrodes 122 are disposed on an inner surface of the first substrate 111. Each of the common electrodes 121 includes a transparent electrode 121a and a bus electrode 121b, and each of the scan electrodes 122 includes a transparent electrode 122a and a bus electrode 122b. The transparent electrodes 121a and 122a are respectively coupled to the bus electrodes 121b and 122b. The transparent electrodes 121a and 122a are formed of indium tin oxide (ITO) in one embodiment. In other embodiments, the transparent electrodes 121a and 122a may be formed of other suitable material.

The address electrodes 123 are disposed on an inner surface of the second substrate 112.

In the first embodiment, the common electrodes 121 and the scan electrodes 122 are disposed on the inner surface of the first substrate 111, and the address electrodes 123 are disposed on the inner surface of the second substrate 112, but the present invention is not limited thereto. According to the first embodiment of the present invention, the common electrodes 121, the scan electrodes 122 and the address electrodes 123, which are discharge electrodes, may be spaced at a suitable distance (e.g., a predetermined distance) from the inner surfaces of the substrates 110. For example, a plurality of electrodes may be disposed corresponding to a barrier rib structure in one embodiment.

A first dielectric layer 181 into which the common electrodes 121 and the scan electrodes 122 are embedded is disposed on the inner surface of the first substrate 111. The first dielectric layer 181 prevents the common electrodes 121 and the scan electrodes 122 from being directly electrically connected to each other during a discharge, and protects charged particles from colliding against the common electrodes 121 and the scan electrodes 122 in order to protect the common electrodes 121 and the scan electrodes 122.

Also, the first dielectric layer 181 has a function of accumulating wall charges by inducing charged particles. The first dielectric layer 181 is formed of a dielectric material such as PbO, B₂O₃, or SiO₂.

A protective layer 181a is disposed on the first dielectric layer 181, and is formed using, for example, MgO.

The protective layer 181a prevents the common electrodes 121 and the scan electrodes 122 from being damaged by sputtering of plasma particles, and also emits secondary electrons, thus allowing a discharge voltage to be lowered.

The address electrodes 123 are disposed on the inner surface of the second substrate 112, and a second dielectric layer 182 is formed on the second substrate 112, with the address electrodes 123 being embedded in the second dielectric layer 123. The second dielectric layer 182 protects the address electrodes 123 and is formed of, for example, the same material as the first dielectric layer 181.

In the first embodiment, the plasma display panel 100 includes the second dielectric layer 182, but the present invention is not limited thereto. That is, a plasma display panel according to the present invention may not include a second dielectric layer.

The barrier rib structure 130 is formed of a dielectric material, such as PbO, B₂O₃, or SiO₂, and arranged on the second dielectric layer 182. The barrier rib structure 130, together with the substrates 110, defines a plurality of discharge cells 190 in which a discharge occurs. That is, the barrier rib structure 130 defines a display area in which an image is displayed.

The barrier rib structure 130 defines the display area since the discharge cells 190 coated with the phosphor layers 170 are defined by partitioning the space between the substrates 100 by the barrier rib structure 130, but the present invention is not limited thereto.

That is, a barrier rib structure according to the other embodiments of the present invention may further define dummy discharge cells on which an image is not realized. Here, the dummy discharge cells are places having no discharge electrodes or phosphor layers, in which a discharge does not occur. In this case, the dummy discharge cells may be located to correspond to the edges of a plasma display panel or be located between discharge cells for displaying an image.

In the first embodiment, the cross-sections of the discharge cells 190 have a square shape but the present invention is not limited thereto. For example, they may have a polygonal shape, such as a triangle or pentagonal shape, a circular shape, an oval shape or an open stripe shape.

In the first embodiment, the barrier rib structure 130 is formed using a printing method, but the present invention is not limited thereto. For example, a barrier rib structure according to the present invention may be fabricated to have a sheet shape. That is, a barrier rib structure can be fabricated by making a sheet structure using a material for a barrier rib structure and then forming holes corresponding to discharge spaces in the sheet.

The spacers 140 are disposed between the first and second substrates 111 and 112.

The spacers 140 are post-type or rod-like spacers each having an oval cross-section, and are formed of, for example, a ceramic material. The spacers 140, together with the grooves 150, not only allow the first and second substrates 111 and 112 to be spaced at a suitable distance from each other but also allow the first and second substrates 111 and 112 to be appropriately aligned with each other.

The spacers 140 according to the first embodiment each has a continuous rod-like shape and an oval cross-section, but the present invention is not limited thereto. That is, spacers according to other embodiments of the present invention may have a cross-section in a square, circular or polygonal shape, and may be formed to have short and discontinuous segments.

The spacers 140 according to the first embodiment are formed of a ceramic material but the present invention is not limited thereto. That is, a material for spacers according to the present invention is not limited. For example, they can be formed of glass, metal, or a mixture of glass, metal and ceramic. Alternatively, they may be fabricated by grinding the material for the spacers into powder, and then molding and sintering the resultant structure.

According to the first embodiment, two spacers 140 are disposed along each of the edges of the plasma display panel 100, but the total number of spacers according to the present invention is not limited thereto. For example, one, three or four spacers may be disposed.

The grooves 150 are formed along the edges of the first and second substrates 111 and 112. The grooves 150 are formed in stripes, and the plasma display panel 100 is assembled by inserting the spacers 140 into the grooves 150.

The grooves 150 include first grooves 151 formed along the edges of the first substrate 111 and second grooves 152 formed along the edges of the second substrate 112. The first grooves 151 are formed in the first substrate 111, the first dielectric layer 181 and the protective layer 181a, and the second grooves 152 are formed in the second substrate 112 and the second dielectric layer 182.

The grooves 150 are formed in the first and second substrates 111 and 112 by using, for example, a mechanical glass cutting processing method but the present invention is not limited thereto. That is, according to the present invention, the grooves 150 can be formed using various methods. For example, they can be formed by using a laser processing method, sand blasting, or etching.

Each of the grooves 150 has a shape allowing a part of one of the spacers 140 to be inserted thereinto so that they can be coupled to each other. In the first embodiment, the spacers 140 are formed in an oval shape, and thus the grooves 150 are formed in an oval arc shape.

In the first embodiment, the grooves 150 are formed in both the first and second substrates 111 and 112 but the present invention is not limited thereto. For example, grooves according to other embodiments of the present invention may be formed in one of a first substrate and a second substrate.

In the first embodiment, two grooves 150 are formed along the edges of the first substrate 111 and the second substrate 112, but the present invention is not limited thereto. That is, the total number of grooves according to other embodiments of the present invention is not limited. For example, one, three, four or five grooves 150 may be formed.

A frit 160 is disposed between the spacers 140.

The frit 160 is baked in order to seal the pair of substrates 110. In the first embodiment, since the frit 160 is disposed between the spacers 140, it may prevent the frit 160 from penetrating through the barrier rib structure 130.

In the first embodiment of the present invention, the frit 160 is disposed between the spacers 140, but the present invention is not limited thereto. That is, according to other embodiments of the present invention, the spacers 140 and the frit 160 may be separated from one another.

The phosphor layers 170 are formed on the second dielectric layer 182 in the discharge cells 190 and on the inner side surfaces of the barrier rib structure 130. The phosphor layers 170 each emitting blue, red, or green visible light are applied to the discharge cells 190.

The phosphor layers 170 contain a material that generates visible light in response to UV rays. By way of example, the phosphor layers 170 for emitting red visible light contain a phosphor material Y(V,P)O₄:Eu, the phosphor layers 170 for emitting green visible light contain a phosphor material Zn₂SiO₄:Mn, and the phosphor layers 170 for emitting blue visible light contain a phosphor material BAM:Eu.

In the first embodiment, the phosphor layers 170 are formed on the second dielectric layer 182 in the discharge cells 190 and on the inner sides of the barrier rib structure 130, but the present invention is not limited thereto. That is, phosphor layers according to other embodiments of the present invention can be formed at various locations in the discharge cells as long as they can emit visible light after exposing to UV rays generated by a plasma discharge in a discharge space.

After sealing the plasma display panel 100, the plasma display panel 100 is filled with a discharge gas, such as a neon (Ne) gas, a xenon (Xe) gas, or a mixture thereof.

A manufacturing process and operation of the plasma display panel 100 according to the first embodiment will now be described in detail.

The manufacturing process of the plasma display panel 100 according to the first embodiment may be largely divided into a process of placing and arranging the discharge electrodes 120, a process of forming the grooves 150, a process of applying the frit 160, an assembly process, a sealing process, and a process of injecting a discharge gas.

First the common electrodes 121 and the scan electrodes 122 are disposed on the first substrate 111. Next, the first dielectric layer 181 is formed to cover the common electrodes 121 and the scan electrodes 122, and the protective layer 181a is formed on the first dielectric layer 181 from, for example, magnesium oxide with a vapor deposition method. Also, the first grooves 151 are formed along an edge of the first substrate 111 according to a cutting processing method.

Also, the address electrodes 123 are disposed on the second substrate 112. Next, the second dielectric layer 182 is formed to cover the address electrodes 123, the barrier rib structure 130 is formed on the second dielectric layer 182, and then the phosphor layers 170 are formed in the discharge cells 190. Then, the second grooves 152 are formed along an edge of the second substrate 112 according to the cutting processing method.

Next, the first and second substrates 111 and 112 are attached together by aligning them with each other and by placing the spacers 140 in the first and second grooves 151 and 152. Then the frit 160 is applied between the spacers 140 and baked in order to seal the first and second substrates 111 and 112. Here, the spacers 140 are fixed after being inserted into the first and second grooves 151 and 152, thus helping the first and second substrates 111 and 112 to be aligned with each other.

After sealing the first and second substrates 111 and 112 together, a vacuum exhaust process is performed on the plasma display panel 100, and then a discharge gas is injected into the plasma display panel 100.

The operations of the plasma display panel 100 manufactured according to the exemplary method set forth above will now be described.

After the plasma display panel 100 is assembled and filled with a discharge gas, an address voltage (e.g., a predetermined address voltage) from an external power source is applied between the address electrodes 123 and the scan electrodes 122 in order to perform an address discharge to select the discharge cells 190 in which a sustain discharge is to occur.

When a discharge sustain voltage is applied between the common electrode 121 and the scan electrode 122 of the selected discharge cell 190, the voltage causes the wall charges accumulated along a side surface of the barrier rib structure 130 to move, thus causing a sustain discharge. Then the energy level of the discharge gas excited by the sustain discharge lowers, and UV rays are emitted as a result.

The UV rays excite the phosphor in the phosphor layers 170 applied to the inside the discharge cell 190, and when the energy level of the excited phosphor lowers, visible light is emitted. The visible light passes through the first substrate 111, thereby forming an image that a viewer can recognize.

As described above, according to the first embodiment, the spacers 140 allow the first substrate 111 to be spaced at a substantially constant distance from the second substrate 112, thereby preventing vibration and noise from occurring.

Also, according to the first embodiment, the spacers 140 and the grooves 150 allow the first and second substrates 111 and 112 to be easily aligned with each other during assembling and sealing of the plasma display panel 100. That is, since the plasma display panel 100 is assembled by inserting the spacers 140 into the grooves 150, the alignment can be simplified and precisely performed. Thus cost for the alignment of the substrates can be reduced, and a discharge error can be prevented or reduced when driving the plasma display panel 100.

FIG. 3 is a partial cross-sectional view of a plasma display panel according to another embodiment that is a modified example of the first embodiment of the present invention. The plasma display panel 200 illustrated in FIG. 3 will now be described relative to the plasma display panel 100 according to the first embodiment while focusing on the differences therebetween.

Referring to FIG. 3, the plasma display panel 200 includes a barrier rib structure 230 disposed between a first substrate 211 and a second substrate 212, a first dielectric layer 281 covering a common electrode (not shown) and a scan electrode (not shown), a second dielectric layer 282 covering an address electrode (not shown), and a protective layer 281a.

The first and second dielectric layers 281 and 282 are formed so as not to reach one edge of the first substrate 211 and one edge of the second substrate 212, respectively. Thus, first grooves 251 are formed only in the first substrate 211, and second grooves 252 are formed only in the second substrate 122.

Spacers 240 are formed in a pole shape having a rectangular cross-section. The spacers 240 are fabricated, for example, by grinding a mixture of glass and ceramic into powder, and then molding and sintering the powder in a square pole shape.

The first and second grooves 251 and 252 are respectively formed in the first and second substrates 211 and 212.

The spacers 240 are fixed as a result of being inserted into the respective first and second grooves 251 and 252. The inner surfaces of the first and second grooves 251 and 252 form right angles in order to match the shapes of the spacers 240.

The frits 260 are disposed between the spacers 240 and on the outer side of the outermost spacer 240.

In the case of the plasma display panel 200, the first and second substrates 211 and 212 are spaced at a substantially constant distance from each other because of the spacers 240 and the grooves 250. Further, the spacer 240 and the grooves 250 facilitate the alignment between the first and second substrates 211 and 212 during the assembling and sealing processes.

By way of example, since the spacers 240 have a rectangular cross-section, they can be inserted into the first and second grooves 251 and 252 precisely as designed. Thus it is very easy to precisely align the first and second substrates 211 and 212 with each other, thereby simplifying the alignment process and preventing or reducing a discharge error when the plasma display panel 200 is driven after the sealing process.

Other aspects of the construction, operations and features of the plasma display panel 200 are the same as those of the plasma display panel 100 according to the first embodiment.

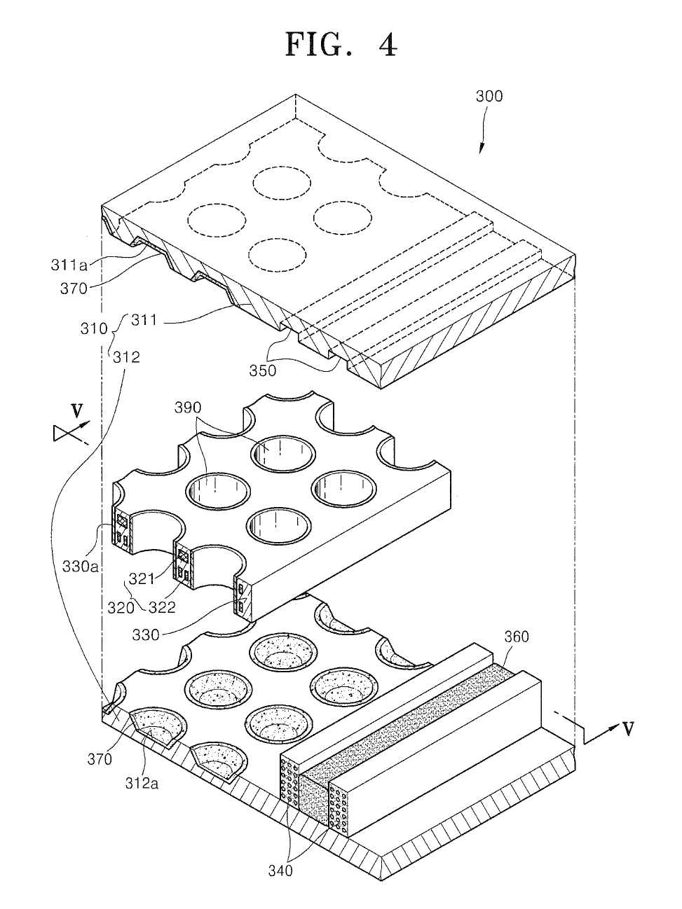

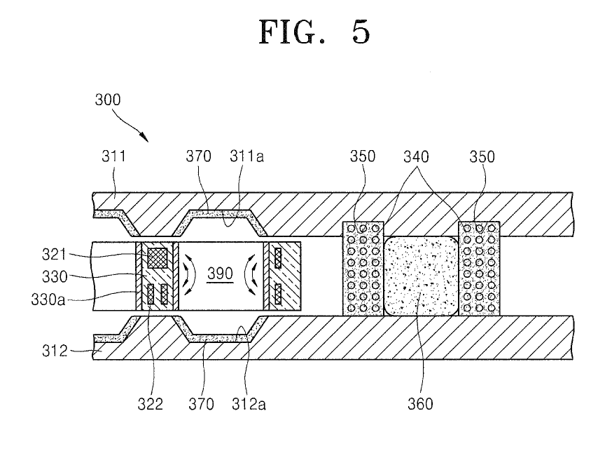

FIG. 4 is a partially exploded perspective view of a plasma display panel 300 according to a second embodiment of the present invention. FIG. 5 is a cross-sectional view of the plasma display panel 300 taken along the line V-V.

Referring to FIGS. 4 and 5, the plasma display panel 300 includes a pair of substrates 310, discharge electrodes 320, a barrier rib structure 330, spacers 340, grooves 350, a frit 360, and phosphor layers 370.

The substrates 310 includes a first substrate 311 and a second substrate 312. The first and second substrates 311 and 312 are spaced at a suitable distance from each other while facing each other. The first substrate 311 is fabricated using, for example, transparent glass and thus visible light is allowed to pass through the first substrate 311.

The discharge electrodes 320 are disposed inside the barrier rib structure 330 and includes first discharge electrodes 321 and second discharge electrodes 322.

The first and second discharge electrodes 321 and 322 are spaced at a suitable distance from each other but are extended to cross each other.

In the second embodiment, the first discharge electrodes 321 are extended in one direction and the second discharge electrodes 322 are formed to cross the first discharge electrodes 321 in order to perform an addressing operation, but the present invention is not limited thereto. That is, a plasma display panel according to other embodiments of the present invention may be constructed to have a three-electrode structure including an electrode for only an addressing operation.

The first and second discharge electrodes 321 and 322 are aligned to surround discharge cells 390. The first and second discharge electrodes 321 and 322 form a circular ring shape but the present invention is not limited thereto. That is, portions of the first and second discharge electrodes 321 and 322 that surround the discharge cells 390 may be formed in various shapes, such as a trapezoidal shape, an oval ring shape, or a polygonal shape.

Since the first and second discharge electrodes 321 and 322 according to the second embodiment surround the discharge cells 390, a sustain discharge occurs at all vertical side surfaces of the barrier rib structure 330 defining the discharge cells 390, but the present invention is not limited thereto. That is, first and second discharge electrodes according to other embodiments of the present invention may be formed in stripes in order to be embedded into a barrier rib structure. However, in this case, an opposing discharge occurs between the first and second discharge electrodes. The first and second discharge electrodes may form various structures, such as a discontinuous ring structure that may be disposed to partially surround discharge cells.

Since the first and second discharge electrodes 321 and 322 according to embodiments of the present invention are disposed inside the barrier rib structure 330, they do not need to be transparent electrodes. For example, the first and second discharge electrodes may be formed of a metal material having good conductivity and low resistivity, e.g., Ag, Al or Cu. In this case, it is possible to guarantee a fast response speed, prevent signal distortion, and reduce the amount of power required for a sustain discharge.

The barrier rib structure 330 is disposed between the substrates 310 and has a sheet shape. The barrier rib structure 330 defines the discharge cells 390, and the discharge electrodes 320 are embedded into the barrier rib structure 330 as described above.

The cross sections of the discharge cells 390 defined by the barrier rib structure 330 have a circular shape in the second embodiment, but the present invention is not limited thereto. The cross sections of the discharge cells 390 in other embodiments may have a polygonal shape (e.g., a triangular, square, or pentagonal shape) or an oval shape.

A dielectric used to fabricate the barrier rib structure 330 prevents the first and second discharge electrodes 321 and 322 from being directly electrically connected to each other during a sustain discharge, protects the first and second discharge electrodes 321 and 322 by preventing charged particles from colliding against them, and can induce charged particles in order to accumulate wall charges. The dielectric may be, for example, PbO, B₂O₃, or SiO₂.

The side surfaces of the barrier rib structure 330 are covered with a protective layer 330a. The protective layer 330a is formed of, for example, magnesium oxide (MgO), and protects the barrier rib structure 330 formed of a dielectric and the first and second discharge electrodes 321 and 322 from sputtering of plasma particles. Further, the protective layer 330a emits secondary electrons, thereby allowing a discharge voltage to be lowered.

The spacers 340 are disposed between the first and second substrates 311 and 312.

The spacers 340 have a pole shape having rectangular cross-sections. The spacers 340 maintain a substantially constant distance between the first and second substrates 311 and 312, and together with the grooves 350, allow the first and second substrates 311 and 312 to be appropriately aligned with each other.

The spacers 340 according to the second embodiment are formed of, for example, ceramic. They are fabricated by grinding ceramic into different sized powders, and molding and sintering the powders.

The grooves 350 are formed along the edges of the first substrate 311 in stripes. The spacers 340 are fixed by inserting first ends of them into the grooves 350 during the assembly process.

The grooves 350 are formed in only the first substrate 311 unlike in the plasma display panel 100 according to the first embodiment. That is, the first ends of the spacers 340 are inserted into the grooves 350 but the second ends thereof are fixed on the second substrate 312.

The grooves 350 are formed in the first substrate 311 using, for example, a laser cutting processing method. The grooves 350 are shaped in such a manner that their surfaces form a right angle in order to be precisely coupled with the spacers 340.

In the second embodiment, two grooves 350 are formed along each of the edges of the first substrate 311, but the present invention is not limited thereto. That is, the total number of grooves according to other embodiments of the present invention is not limited. For example, one, three, four, or five grooves may be formed along each of the edges of the first substrate 311.

The frit 360 is disposed between the spacers 340.

The frit 360 is baked in order to seal the substrates 310. The frit 360 is disposed between the spacers 340 so as not to permeate the barrier rib structure 330.

The phosphor layers 370 are formed in phosphor accommodating grooves 311a in the first substrate 311 and phosphor accommodating grooves 312a in the second substrate 312. The phosphor accommodating grooves 311a and 312a are formed in portions of the first and second substrates 311 and 312 in which the discharge cells 390 are to be located by using various methods, such as glass cutting processing, sand blasting, or etching.

The phosphor layers 370 contain a substance emitting visible light when UV rays are incident thereon. The phosphor layers 370 emitting red visible light contain a phosphor such as Y(V,P)O₄:Eu, the phosphor layers 370 emitting green visible light contain a phosphor such as Zn₂SiO₄:Mn, and the phosphor layers 370 emitting blue visible light contain a phosphor such as BAM:Eu.

In the second embodiment, the phosphor layers 370 are arranged by forming the phosphor accommodating grooves 311a in the first substrate 311 and the phosphor accommodating grooves 311b in the second substrate 312, and then applying a phosphor onto the phosphor accommodating grooves 311a and 312a, but the present invention is not limited thereto. That is, phosphor layers according to other embodiments of the present invention may be formed on any location, e.g., the inner side surfaces of the barrier rib structure 330 or any part of the discharge cells 390, as long as they can emit visible light in a discharge space after exposing to UV rays generated by a plasma discharge.

After sealing the substrates 310, the discharge cells 390 between them are filled with a discharge gas, such as Ne, Xe or a mixture thereof.

Next, a manufacturing process and operation of the plasma display panel 300 according to the second embodiment will be described in detail.

The manufacturing process of the plasma display panel 300 is largely divided into a process of forming the barrier rib structure 330, a process of forming the grooves 350, an assembling process, a sealing process, and a process of injecting a discharge gas.

First, in the process of forming the barrier rib structure 330, a manufacturer fabricates the barrier rib structure 330 by forming a dielectric layered structure in a sheet shape while embedding the first and second discharge electrodes 321 and 322 thereinto, and then making circular holes in the structure in which the discharge cells 390 are to be located.

The protective layer 330a is formed to cover the side surfaces of the barrier rib structure 330, using, for example, magnesium oxide and a vacuum deposition method.

Next, parts of the substrates 310 in which the discharge cells 390 are to be located are processed using a glass cutting method, such as glass cutting, sand blasting, or etching, in order to form the phosphor accommodating grooves 311a and 312a. Then a phosphor is applied onto the phosphor accommodating grooves 311a and 312a in order to obtain the phosphor layers 370.

Also, the manufacturer forms the grooves 350 in an outer edge of the first substrate 311 using, for example, glass cutting, sand blasting, or etching.

Next, the spacers 340 are fixed on the second substrate 312 at positions corresponding to the position of the respective grooves 350, using, for example, an adhesive.

Next, the barrier rib structure 330 is inserted between the substrates 310, first ends of the spacers 340 are inserted into the grooves 350, the frit 360 is applied between the spacers 340, and then the first and second substrates 311 and 312 are sealed together and baked. Here, the spacers 340 are fixed while being inserted into the grooves 350, and thus the first and second substrates 311 and 312 can be easily aligned with each other.

After completing the sealing, the vacuum exhaust process is performed on the plasma display panel 300, and then a discharge gas is injected into the plasma display panel 300.

The operation of the plasma display panel 300 manufactured as described above will now be described.

After assembling the plasma display panel 300 and injecting a discharge gas thereinto, an address voltage (e.g., a predetermined address voltage) is applied between the first and second discharge electrodes 321 and 322 from an external power source in order to perform an address discharge to select the discharge cells 390 where a sustain discharge is to occur later.

Thereafter if a discharge sustain voltage is applied between the first and second discharge electrodes 321 and 322 in a selected discharge cell 390, wall charges accumulated along the side surfaces of the barrier rib structure 330 move in response to the discharge sustain voltage and thus causing a sustain discharge to occur. Then the energy level of the discharge gas excited by the sustain discharge lowers, causing UV rays to be emitted.

The UV rays excite the phosphor layers 370 within the discharge cells 390. Next the energy levels of the excited phosphor layers 370 lower to emit visible light, and then the visible light passes through the first substrate 311, thereby forming an image that a viewer can recognize.

The plasma display panel 300 according to the second embodiment is constructed in such a manner that the discharge cells 390 are surrounded by the first and second discharge electrodes 321 and 322. In this case, a sustain discharge occurs along all side surfaces of the discharge cells 390, thereby increasing a discharge space and the luminance and discharge efficiency.

The plasma display panel 300 according to the second embodiment has the barrier rib structure 330 in a sheet shape. That is, in the second embodiment, after the sheet type barrier rib structure 330 is formed, the discharge cells 390 are formed by making only circular holes on the barrier rib structure 330, thereby simplifying the manufacturing process and reducing the manufacturing costs.

Also, in the second embodiment, the first and second substrates 311 and 312 can be spaced at a substantially constant distance from each other due to the spacers 340, thereby preventing vibration and noise from occurring.

Also, in the second embodiment, the first and second substrates 311 and 312 can be easily aligned with each other by using the spacers 340 and the grooves 350 when assembling and sealing the plasma display panel 300. That is, by inserting the spacers 340 into the grooves 350, an alignment process during assembly of the plasma display panel 330 can be simplified and precisely performed. Therefore, the cost for the alignment process can be reduced, and the precise alignment prevents an error from occurring during a discharge when the plasma display panel 300 is driven after the sealing process.

While this invention has been particularly shown and described with reference to exemplary embodiments thereof, it will be understood by those skilled in the art that various changes in form and details may be made therein without departing from the spirit and scope of the invention as defined by the appended claims and their equivalents.

1. A plasma display panel comprising:
first and second substrates facing each other;
a plurality of discharge electrodes between the first and second substrates;
a barrier rib structure between the first and second substrates and together with the first and second substrates defining a plurality of discharge cells;
at least one spacer between the first and second substrates for maintaining a substantially constant distance between the first and second substrates;
at least one groove located in at least one of the first and second substrates, wherein the at least one spacer is in the at least one groove;
a frit between the first and second substrates for sealing the first and second substrates together;
a plurality of phosphor layers in the plurality of discharge cells; and
a discharge gas in the plurality of discharge cells.

2. The plasma display panel of claim 1, further comprising at least one dielectric layer between the first and second substrates, wherein the at least one dielectric layer covers the plurality of discharge electrodes.

3. The plasma display panel of claim 2, further comprising a protective layer on the at least one dielectric layer.

4. The plasma display panel of claim 1, wherein the plurality of discharge electrodes are inside the barrier rib structure.

5. The plasma display panel of claim 4, wherein at least one of the plurality of discharge electrodes surrounds at least parts of the plurality of discharge cells.

6. The plasma display panel of claim 1, wherein the barrier rib structure has a substantially sheet shape.

7. The plasma display panel of claim 1, wherein the at least one spacer comprises at least one of glass, metal, or ceramic.

8. The plasma display panel of claim 7, wherein the at least one spacer is made of material that has been ground into powder.

9. The plasma display panel of claim 1, wherein the at least one spacer comprises a plurality of spacers, and the frit is between the plurality of spacers.

10. The plasma display panel of claim 1, wherein the at least one spacer is proximate to the frit.

11. The plasma display panel of claim 1, wherein the at least one groove comprises a plurality of grooves in both the facing substrates, and the at least one spacer comprises a plurality of spacers each being in a corresponding one of the plurality of grooves.

12. The plasma display panel of claim 1, wherein
the at least one groove is in one of the first substrate or the second substrate,
one end of the at least one spacer is in the at least one groove, and
the other end of the at least one spacer is fixed on the other one of the first substrate or the second substrate.

13. A plasma display panel comprising:
a first substrate;
a second substrate facing the first substrate;
a barrier rib structure between the first substrate and the second substrate, the barrier rib structure having a plurality of openings each exposing a corresponding portion of the first substrate to a corresponding portion of the second substrate;
a plurality of discharge electrodes in the barrier rib structure together with the first substrate and the second substrate define a plurality of discharge cells;
at least one spacer between the first substrate and the second substrate for maintaining a substantially constant distance between the first substrate and the second substrate;
at least one groove located in at least one of the first substrate and the second substrate, wherein the at least one spacer is in the at least one groove;
a frit between the first substrate and the second substrate for sealing the first and second substrates together.

14. A plasma display panel of claim 13, wherein a surface of at least one of the plurality of openings is substantially perpendicular to the first substrate and the second substrate.

15. A plasma display panel of claim 13, wherein at least one of the plurality of discharge electrodes surrounds at least one of the plurality of openings.

16. A plasma display panel of claim 13, wherein at least one of the plurality of openings has a substantially cylindrical shape.
